(19) United States
(12) Patent Application Publication
(10) Pub. No.: US 2018/0243767 A1
(43) Pub. Date: Aug. 30, 2018

(54) TWO-COMPONENT SPRAY POLYURETHANE FOAM DISPENSER WITH CONTINUOUS GAS PURGING

(71) Applicant: Dow Global Technologies LLC, Midland, MI (US)

(72) Inventors: Gregory T. Stewart, Midland, MI (US); Daniel R. Schroer, Saginaw, MI (US); Timothy P. Fournier, Auburn, MI (US)

(21) Appl. No.: 15/749,379

(22) PCT Filed: Sep. 12, 2016
(86) PCT No.: PCT/US2016/051211

§ 371 Date: Jan. 31, 2018

Related U.S. Application Data
(60) Provisional application No. 62/221,899, filed on Sep. 22, 2015.

(51) Int. Cl. B05B 7/00; B05B 1/30; B05B 7/04; B05B 7/24; B05B 12/00; B05B 15/55; B29B 7/74; C08G 18/08; C08J 9/04

(52) U.S. Cl. CPC B05B 7/0025; B05B 1/3026; B05B 7/0408; B05B 7/0416; B05B 7/2497; C08J 2375/04; B05B 15/55; B29B 7/7447; B29B 7/7419; C08G 18/14; C08J 9/04; B05B 12/002

(57) ABSTRACT

A dispenser (10) comprises a housing (20) defining at least three feed channels (23, 24, 25) and at least one dispensing channel (26), a spool valve (28, 30) with a spool (30) defining at least four flow passages (31, 32, 33, 34), a deformable sealing plug (40) in at least two (23, 24) of the feed channels and in sealing orientation with both the housing (22) and the spool (30), and a nipple (50) in at least the two feed channels (23, 24) of the housing (22) comprising the sealing plugs (40); wherein the spool (30) can reversibly rotate between an open orientation and a closed orientation can dispense two-component foam formulations and purges the dispensing channel when in the off position.

### BACKGROUND OF THE INVENTION

### Field of the Invention

The present invention relates to a dispensing device useful for dispensing two-component polyurethane foam formulations.

### Introduction

Dispensing devices for fluid components are in wide use for application of mixed fluids, especially in the area of polyurethane systems such as polyurethane foam systems. Two component polyurethane (2k-SPU) foam formulations are typically applied by simultaneously feeding an isocyanate component (A Component) with a polyol component (B Component) to create a mixture and then spraying the mixture from a dispenser.

2k-SPU foam systems are generally classified into two classes: those that contain a gaseous blowing agent (GBA) in one or both of the A and B Component prior to application and those that are free of GBA in either A or B Component prior to application (“GBA-Free 2k-SPU foam systems”). GBAs are blowing agents that have a vapor pressure greater than 0.23 Mega Pascals (MPa) at 25 degrees Celsius (° C.). Typical GBAs include 1,1,2,2-tetrafluoroethane (HFC-134a), carbon dioxide, nitrogen, and 1,3,3,3-tetrafluoropropene (1234ze). GBAs are beneficial in a 2k-SPU not only as frothing aids but to lower the viscosity of the component they are in. Lower viscosity components are easier to dispense because they require less pressure to flow through flow channels of a dispenser.

GBA-Free 2k-SPU foam systems generally require a pressurized gas as a third feed concomitant with the A and B components when dispensing the 2k-SPU foam system. GBA-Free 2k-SPU foam systems can be high pressure systems or low pressure systems. In high pressure systems, which are systems that require dispensing pressures greater than 4 Mega Pascals (MPa), the pressurized gas helps shape the spray. In low pressure systems, which are systems that can be dispensed at pressures lower than 4 MPa, typically lower than 2 MPa, the pressurized gas is useful as a motive and mixing force for the A and B components. The requirement of a pressurized gas means that a dispenser requires at least three simultaneous feeds as opposed to two feed for 2k-SPU foam systems containing GBA. Additionally, the lack of GBA means that the A and B components are typically higher viscosity than in 2k-SPU foam systems containing GBA, which means the dispenser requires higher pressures, larger feed channels or both.

GBA-Free 2k-SPU foam systems, even low pressure systems, are more challenging to apply than other 2k-SPU foam systems not only because they are more viscous, but because the dispenser tends to plug more quickly if dispensing is started and stopped repeatedly. For example, 2k-SPU foam systems containing GBA prior to application do not tend to plug the dispenser even when repeatedly starting and stopping flow for about 30 seconds and then starting flow again. In contrast, GBA-Free 2k-SPU foam systems tend to plug the dispenser after just a few such cycles. As a result, it is more difficult to apply GBA-Free 2k-SPU foam systems because stopping flow of fluids to move equipment can result in plugging of the dispenser.

It would desirably advance the art to develop a dispenser for GBA-Free 2k-SPU foam systems, even low pressure systems, that prevents plugging of the dispenser when the dispenser is in an “off” position and is not applying the foam system. Even more desirable is such a dispenser that does not require activating one trigger to turn the dispenser on and off and a second trigger to purge the dispenser of 2k-SPU foam system components that have been mixed together.

### BRIEF SUMMARY OF THE INVENTION

The present invention provides a dispenser for GBA-Free 2k-SPU foam systems, even low pressure systems, that prevents plugging of the dispenser when the dispenser is in an “off” position and is not applying the foam system. Moreover, the present invention provides a dispenser that does not require activating one trigger to turn the dispenser on and off and a second trigger to purge the dispenser of 2k-SPU foam system components that have been mixed together.

The present invention is a result of discovering that designs such as those in PCT Application number CN14/086506 which have a “bleed groove” in the spool fail to provide enough air flow volume in the off position to satisfactorily purge the dispensing channel of the 2k-SPU formulation. Moreover, the present invention is a result of discovering that providing a fourth flow passage through the spool of the dispenser that aligns a gas feed channel with the dispensing channel when in the closed position allows the gas to expel residual 2k-SPU reactants in the dispensing channel without requiring any extra step, such as pulling a second trigger. A continuous flow of gas through the dispensing channel while in the “off” position ensures the dispensing channel does not plug between applications of the GBA-Free 2k-SPU foam system components. Use of a continuous flow of gas whether 2k-SPU is being applied or not is an improvement over using temporary bursts of gas through the dispensing channel because it provides continual purging of the dispensing channel rather than guessing how long gas flow is needed to purge the reactive system components from the dispensing channel.

Even more, it was unexpectedly discovered that optimal dispenser performance, in terms of dispensing GBA-Free 2k-SPU foam system components when in the “on” position and cleaning of the system components from the dispensing channel when in the “off” position, occurs when the fourth flow passage has a larger cross sectional area than the third flow passage when the third flow channel is the flow channel that aligns with a feed channel through which gas flows and the dispensing channel when the dispenser is in the “on” position and the fourth flow passage aligns with the feed channel through which gas flows and dispensing channel when in the “off” position. The smaller cross sectional area of the third flow passage results in higher pressure gas flow to assist in dispensing the 2k-SPU foam system components while the larger cross sectional area of the fourth flow passage results in lower gas pressure but greater gas volume for purging the dispensing channel. Experiments have shown that the lower pressure and higher volume gas flow is more effective at purging the dispensing channel than lower volume and higher pressure gas.

In a first aspect, the present invention is a dispenser (10) comprising: (a) a housing (20) with a feed end (21) and an opposing dispensing end (22), the feed end having defined therein at least three feed channels (23, 24 and 25) and the dispensing end having defined therein at least one dispensing channel (26); (b) a spool valve mounted in the housing between the feed end and dispensing end, the spool valve comprising a spool (30) with separate first, second and third flow passages (31, 32 and 33) and a fourth flow passage (34) that optionally intersects the third flow passage, where the flow passages are defined through the spool and each flow passage has a feed end opening (31a, 32a, 33a and 34a, respectively) and a dispensing end opening (31b, 32b, 33b and 34b, respectively), the spool has at least four gasket grooves (38a, 38b, 38c and 38d) defined circumferentially around the spool and in each of which a gasket (100a, 100b, 100c and 100d, respectively) resides so that each gasket presses against the spool and housing to form a seal around the circumference of the spool with a gasket groove defined on each side of the feed end opening and dispensing end opening of each of the four flow passages such that the feed end opening and dispensing end opening of the third and fourth flow passages residing between the same two gasket grooves while the first flow passage feed end opening and dispensing end opening are the only flow passage openings of the four flow passages residing between one pair of gasket grooves and the second flow passage feed end opening and dispensing end opening are the only flow passage openings of the four flow passages residing between a second pair of gasket grooves; (c) a deformable sealing plug (40) in at least two feed channels positioned so as to be in a sealing orientation with the housing about the feed channel so as to prevent fluid communication through the feed channel around the sealing plug, the sealing plug having opposing spool end (41) and feed end (42) and a flow channel (43) extending through the sealing plug and through the opposing ends of the sealing plug, wherein the spool end of the sealing plug is pressing against and is in sealing contact with the spool, the entire sealing plug being elastomeric and deformable; and (d) a nipple (50) in each of at least the two feed channels of the housing containing sealing plugs and extending inside and out from the feed end of the feed channels, the nipples having opposing entrance end (51) and exit end (52) and a flow channel (53) extending through each nipple, including through the exit and entrance ends, the nipples oriented such that the exit end of a nipple presses against the feed end of a sealing plug within the feed channel of the housing and such that the flow channels of sealing plug and nipple are in fluid communication, the nipples being free of screw threading that screws the nipple into the feed channel; wherein the spool can reversibly rotate between: (i) an open position where each of the three distinct flow passages through the spool aligns in fluid communication each with distinct feed and dispensing channels of the housing with the first and second flow passages through the spool achieving fluid communication with a feed channel of the housing through a flow channel of a sealing plug and nipple and through a dispensing channel; and (ii) a closed position where the first and second flow passage through the spool are not in fluid communication with a feed channel of the housing and the fourth flow passage is in fluid communication with feed and dispensing channels of the housing that the third flow passage was in fluid communication with when in the open position.

The dispenser of the present invention is useful for dispensing two-component spray polyurethane foam systems.

### BRIEF DESCRIPTION OF THE DRAWINGS

FIG. 1 illustrates a dispenser of the present invention.

FIG. 2 illustrates and exploded view of the dispenser of FIG. 1.

FIG. 3 illustrates a cut-away view of the dispenser of FIG. 1.

FIGS. 4a and 4b are larger images of the sealing plug of the dispenser in FIG. 1.

FIGS. 5 illustrates a spool that can be used with dispensers of the present invention.

### DETAILED DESCRIPTION OF THE INVENTION

“And/or” means “and, or as an alternative”. All ranges include endpoints unless otherwise indicated. “Multiple” means two or more.

The mixing device of the present invention comprises a housing with a feed end and an opposing dispensing end. The feed end of the housing has defined therein at least three feed channels. The dispensing end has at least one dispensing channel in fluid communication with the feed channels.

The feed channels and dispensing channel(s) are enclosed by the housing with openings providing access into and out from the channels through the housing.

Desirably, the feed channels are free of threading that allows an element to screw into the feed channel. Threading in a feed channel is part of the housing defining the feed channel. A threaded element can screw into a feed channel that has threading by interlocking with the threads of the housing within the feed channel and rotating to be drawn into (or out from) the feed channel. Desirably, the feed channel is also free of components that have defined therein threads which an element can screw into. Components in the feed channel are desirably frictionally fit or pressure fit into the feed channel, which means that friction between the component and housing around the feed channel hold the element in place.

The present dispenser can accommodate multiple designs for orienting the feed channels with respect to one another. For example, the feed channels can all be in a line (coplanar) with respect to one another. Alternatively, two of the feed channels can be in a line with a third feed channel out of line with the other two (non-coplanar with the other two) such as in a triangular orientation.

The housing, when the dispenser is in an open orientation, defines at least one dispensing channel in fluid communication with the feed channels. When dispensing 2k-SPU foam formulation, the A and B Component and the gas component flow through independent feed channels and are combined within the housing prior to being dispensed from the housing through one or more than one dispensing channel. Notably, the housing can be a single piece or comprise multiple pieces that fit together. For example, the dispensing channel or channels may be defined in a piece that is removably attached to another piece defining the feed channels.

The dispenser comprises a spool valve in the housing between the feed channels and the dispensing channel(s). The spool valve comprises a spool that rotates between an open orientation and a closed orientation. Desirably, the spool is of a general cylindrical shape with an essentially circular cross section on an axis that traverses the feed and dispensing channels and about which the spool rotates. The spool has separate first, second and third flow passages and a fourth flow passage that optionally intersects the third flow passage. Each of the flow passages has a feed end opening and a dispensing end opening defined in the spool. Each of the flow passages is desirably entirely enclosed within the spool except for the feed end opening and the dispensing end opening of the flow passages.

Desirably, the fourth flow passage has a larger average cross sectional diameter than the third flow passage. In that regard, it is desirable for the fourth flow passage to allow a higher volume of gas to flow through it at a given pressure than the third flow passage. The third and fourth flow passages allow gas to flow through them during operation of the dispenser. The third flow passage allows gas to flow through the spool when the dispenser is in an open orientation. The fourth flow passage allows gas to flow though the spool when the dispenser is in a closed orientation. A larger volume of gas flow is desirable through the fourth flow passage to better purge 2k-SPU spray foam material from the dispensing end of the dispenser.

The third and fourth flow passages can intersect within the spool or can be independent of one another through the spool. It is generally easier to fabricate the spool by allowing the third and fourth flow passages to intersect within the spool. By “intersect” it is meant that there is fluid communication within the spool between the third and fourth flow passages.

The spool has defined circumferentially around the spool at least four gasket grooves with a gasket residing in each one. Each gasket presses against the spool and housing to form a seal around the circumference of the spool. The gasket grooves are positioned such that a gasket groove is defined on each side of the feed end opening and dispensing end opening of each of the four flow passages. The feed end opening and dispensing end opening of the third and fourth flow passages reside between the same two gasket grooves while the first flow passage feed end opening and dispensing end opening are the only flow passage openings of the four flow passages residing between a first pair of gasket grooves and the second flow passage feed end opening and dispensing end opening are the only flow passage openings of the four flow passages residing between a second pair of gasket grooves. So, the spool has at least four gaskets residing around the circumference of the spool such that the opening and dispensing end of the first flow passage resides between a first pair of gaskets, opening and dispensing end of the second flow passage resides between a second pair of gaskets and the opening and dispensing ends of the third and fourth flow passages reside between a third pair of gaskets.

The dispenser comprises deformable sealing plugs in at least two feed channels through which the A and B Components are fed. Each sealing plug is in sealing orientation with the feed channel it is in, which means that there is no fluid communication through the feed channel around the sealing plug. To facilitate achieving a sealing orientation in the feed channel, the sealing plug desirably have a lip molded into it that runs circumferentially around the sealing plug and that presses against the housing within the feed channel in which the sealing plug resides.

The sealing plugs each have opposing spool and feed ends and a flow channel extending through the sealing plug and through the opposing spool and feed ends to create a spool end opening and a feed end opening into the sealing plug flow channel. The flow channel is in fluid communication with outside of the housing through the feed end opening and feed channel. The spool end of the sealing plug presses against the spool. The spool end of the sealing plug is in sealing contact with the spool, and aligns with a flow passage through the spool when the spool is in an open orientation and is sealed against the spool without access to a flow passage in the spool when in a closed orientation, except if there is a sealing plug in a gas feed channel that provides access to the fourth flow channel while in the closed orientation. Sealing contact means that fluid flowing through the sealing plug is prohibited from flowing between the sealing plug and the spool but rather either flows through the sealing plug flow channel into a flow passage of the spool or is prohibited from flowing through the sealing plug flow channel by the spool.

Desirably, the entire sealing plug is elastomeric and conformable. The sealing plug conforms to the housing feed channel in which it resides in order to seal against the housing to prevent fluid flow around the sealing plug within the housing feed channel. The spool end of the sealing plug conforms to the spool as the sealing plug is pressed against the spool so as to form a seal against the spool thereby preventing fluid flow from the flow channel through the sealing plug to the outside of the spool as opposed to into a flow passage of a spool. Desirably, the entire plug is elastomeric and conformable for ease and convenience of manufacture. In fact, it is desirable that the entire seal plug is a made of a single homogeneous composition rather than made of multiple elements of different compositions for ease of manufacture, low cost, and structural integrity of the seal plug. Being made of a single homogeneous material prevents distinct components such as gaskets from becoming displaced from the sealing plug, which can result in leaks.

Desirably, the sealing plug is a unitary structure made from a single homogeneous composition that is an elastomeric polymer. For example, the sealing plug can be made of natural rubber, polyurethane, polybutadiene, neoprene, silicone or preferably an elastomeric rubber made of ethylene propylene diene monomer (EPDM) rubber and polypropylene (for example, the elastomer available under the trade name SANTOPRENE™, SANTOPRENE is a trademark of Exxon Mobil Corporation).

The spool end of the sealing plug desirably has a contoured shape that generally matches the contour of the spool against which the spool end is pressed. For instance, the spool is desirably generally cylindrical in shape with a generally circular cross section so the spool end of the plug desirably has a curved profile to generally match the curve of the outside of the cylindrical spool. By “generally” match it is understood that the contour of the spool end of the sealing plug does not have to be identical to the profile of the outside of the spool against which it presses, though it can be an identical match. The sealing plug is conformable so slight deviations from an identical matching profile can be accommodated while still achieving a sealing configuration with the spool if the profile of the spool end of the sealing plug is not identical to the outside profile of the spool. If the sealing plug is sufficiently conformable, the spool end can be of essentially any shape and still form a sealing configuration with the spool. However, to avoid potential difficulties with rotating the spool between open and closed orientations in the dispenser and to facilitate achieving a sealing configuration with the spool, it is desirable for the spool end of the sealing plug to have a shape generally matching the profile of the outside of the spool.

The sealing plug can include alignment features that facilitate positioning of the sealing plug in a particular orientation with respect to a reference such as the housing or spool. Such alignment features are particularly valuable when the spool end of the sealing plug is contoured to fit the spool because the alignment features allows orientation of the sealing plug so that the sealing plug properly fits to the spool. Alignment features include any characteristic that is part of the sealing plug and that indicates orientation within a feed channel of the housing. For example, the sealing plug can have one or more than one protrusion that extends partially into the flow channel of the sealing plug. Then, the sealing plug can be inserted into the feed channel of the housing in a consistent orientation with respect to the housing for each sealing plug by positioning the protrusion in the same orientation with respect to the housing. For example, a sealing plug can have one or more than one protrusion within the flow channel of the sealing plug that is positioned in a certain direction when the profile of the spool end of the sealing plug is aligned so as to mate with the orientation of the spool. The alignment feature can also be, or alternatively is, on the outside of the sealing plug and fit into a groove or other feature within the feed channel. For example, the sealing plug can have a protrusion, or preferably opposing protrusions, on the surface of the sealing plug that contacts the housing when inserted into the feed channel of the housing and the housing can have corresponding grooves into which the protrusions fit and seal against the housing. Incorporating threading increases cost and complication of manufacture and assembly, which the present invention can avoid.

The sealing plug is desirably free of threading enabling it to screw into a feed channel of the housing, but rather frictionally fits into a feed channel and seals against the housing within the feed channel by pressing against the housing.

The dispenser further comprises a nipple extending inside and out from the feed end of at least the two feed channels of the housing that contain sealing plugs. The nipples have opposing entrance and exit ends and a flow channel extending through each nipple through the entrance end and through the exit end. In at least two of the feed channels of the housing there is both a sealing plug and a nipple oriented such that the exit end of the nipple presses against, preferable directly against, the feed end of the sealing plug and the flow channel of the nipple is in fluid communication with the flow channel of the sealing plug. The sealing plug presses against the spool with its spool end against a nipple with its feed end and, as such, is held in place within the channel by the spool and nipple in addition to the friction between the housing inside the feed channel and the sealing plug. Desirably, the sealing plug forms a seal against the exit end of the nipple so that fluid traveling through the flow channel of the nipple into the flow channel of the sealing plug does not leak out between the nipple and sealing plug where the nipple and sealing plug press against one another.

The nipples are free of threading for screwing into a feed channel of the housing. Instead, the nipples frictionally fit into a feed channel of the housing with the nipple pressing against the housing within the feed channel. The nipple desirably forms a seal with the housing within the feed channel of the housing. The nipple extends out from the feed end of the feed channel of the housing to enable connecting each nipple to a feed line. Any type of connection is possible on the end of the nipple. One convenient form of the nipple has barbs circumferentially around the nipple that extends outside the housing feed channel so the entrance end of the nipple can be positioned into tubing and the barbs frictionally hold the tubing about the nipple. The nipple can alternatively comprise any type of connector such as compressing fitting attachments, pipe thread attachments and the like on the entrance end of the nipple.

The dispenser can further comprise fasteners that extend from outside the housing into the housing proximate to the feed channel and nipple within the feed channel in such a way as to either extend around or into the nipple to further hold the nipple in place in the feed channel. Suitable fasteners include metal staples, metal clips and plastic clips.

The spool of the dispenser is positioned in the housing so that it can reversibly rotate between an open position and a closed position. In the open position, the spool is oriented such that the feed end of the first through third flow passages through the spool aligns in fluid communication each with a flow channel of the housing with at least two of the flow passages achieving fluid communication with a flow channel of the housing through a flow channel of a sealing plug and nipple. Similarly, the three flow passages through the spool are in fluid communication with the dispensing channel of the housing when the spool is in the open position. Hence, when the spool is in an open position, fluid flow is achievable through the nipples and sealing plugs of two feed channels through the spool and through the dispensing channel of the dispenser and fluid flow is simultaneously achievable through a third feed channel (optionally, via a flow channel of a nipple, sealing plug, or both) and through a flow passage in the spool and through the dispensing channel of the dispenser. While it is required that fluid flow is achievable through three flow passages of the spool and through three feed channels of the housing into the dispensing channel of the housing when the spool is in an open orientation, there can be more than three feed channels in the housing each of which are in fluid communication with a flow passage through the spool, optionally through a flow channel of a nipple and/or sealing plug and optionally with the dispensing channel of the housing or some other channel of the housing. Alternatively, the spool can only align three flow passages with three feed channels to achieve fluid communication through the three feed channels and three flow passages into the dispensing channel of the housing.

In the closed position, the spool is oriented with the feed and dispensing ends of the first through third flow passages no longer aligned in fluid communication with a feed channel of the housing, but with the fourth flow passage of the spool aligned with a feed channel and dispensing channel of the dispenser. Typically, when the spool is in the closed position the fourth flow passage aligns with feed channel and dispensing channel that the third flow passage had aligned with when the spool was in the open position.

The dispenser can also include a mixing component after the spool valve wherein fluid flow from two or more, preferably at least three of the feed channels are combined and fed into the dispensing channel of the housing. The mixing component can comprise a static mixing element to facilitate mixing of the fluids from the different feed channels.

The flow passages through the spool can follow similar or different directions with respect to one another through the spool. For instance, the spool can define three flow passages through the spool that all travel in a straight line in plane with a diameter of a cross section of the spool. Such an alignment of spool flow passages is useful when there are three coplanar feed channels in a line and the spool flow passages are desired to have dispensing ends aligned linearly in a plane. When the feed channels are not aligned linearly in a coplanar fashion then at least one of the flow passages through the spool follows a different orientation from the other flow passages. In one desirable configuration, the feed channels are non-planar yet the dispensing openings of the flow passages through the spool are aligned linearly in a coplanar fashion. In such a configuration, two of the spool flow passages can extend along a diameter of a spool cross section and a third spool flow passage follows a curved path that extends from above or below the feed end of the other two flow passages and curves within the spool to align the dispensing end linearly in a coplanar orientation with respect to the dispensing ends of the other two spool flow passages. Such a configuration is desirable to achieve a smaller housing size about the feed channel than might otherwise be achievable if the three feed channels were aligned linearly in a coplanar fashion.

In one desirable embodiment, the first and second feed channels are coplanar and the third feed channel is non-coplanar with any other flow channel and the spool is cylindrical. The first and second flow passages extending radially through the spool and are capable of aligning with two feed channels and the third flow passage entering in a non-coplanar orientation with the other feed channels that are coplanar but exiting the spool aligned in a linear orientation with respect to the other flow passages such that when the spool is oriented in an open orientation the non-planar entrances to the flow passages each align with a different one of the feed channels and fluids flowing through the feed channels proceed through the flow passages of the spool so as to exit the spool flow passages aligned along a plane

The dispenser can comprise a handle, preferably affixed to or molded as a unitary portion of the housing of the dispenser. A handle facilitates holding and aiming of the dispenser.

The dispenser can comprise a trigger attached to the spool so that when the trigger is moved in a first direction the spool rotates to an open orientation and when the trigger moves in an opposite direction relative to the first direction the spool rotates to a closed orientation. The trigger can be as simple as a lever attached to one or both ends of the spool so that moving the lever rotates the spool. Desirably, the dispenser comprises both a handle and a trigger with the trigger connected to the spool and extending in a similar or same plane as the handle so as to allow holding of the dispenser via the handle and opening and closing of the spool by squeezing or releasing the trigger. The dispenser can further comprise a spring that holds the trigger in a position that keeps the spool in a closed orientation unless the trigger is moved and then replaces the trigger in a position that places the spool in a closed orientation when released.

The dispenser of the present invention is useful for dispensing three or more fluids in a controlled manner. A particularly valuable use for the dispenser is for dispensing 2k-SPU foam formulation using a pressurized gas. For example, one method of using the dispenser of the present invention comprises: (A) simultaneously supplying under pressure (i) a liquid isocyanate component (“A component”) into a first feed channel of the housing through the flow channels of a nipple and plug residing in the first feed channel; (ii) a liquid polyol component (“B Component”) into a second feed channel of the housing through the flow channels of a nipple and plug residing in the second feed channel; and (iii) a gas into a third feed channel of the housing, preferably where (i) and (ii) are free of gaseous blowing agents; (B) position the spool of the dispenser to allow the A Component, B Component and gas to flow through separate flow passages through the spool; and (C) dispensing a combination of the A Component, B Component and gas out from the dispensing channel of the housing. The design of the present dispenser is such that the feed channels for the A Component and B Component remain sealed even under pressures necessary for GBA-Free 2k-SPU foam system applications.

The method of using the dispenser can further comprise a step (D) after step (C) where step (D) is positioning the spool of the dispenser in a closed position where the first and second flow passages of the spool are no longer in fluid communication with the first and second feed channel of the housing and where the fourth flow passage of the spool is in fluid communication with the third flow channel of the housing and gas flows through the fourth flow passage of the spool and out from the dispensing channel of the housing

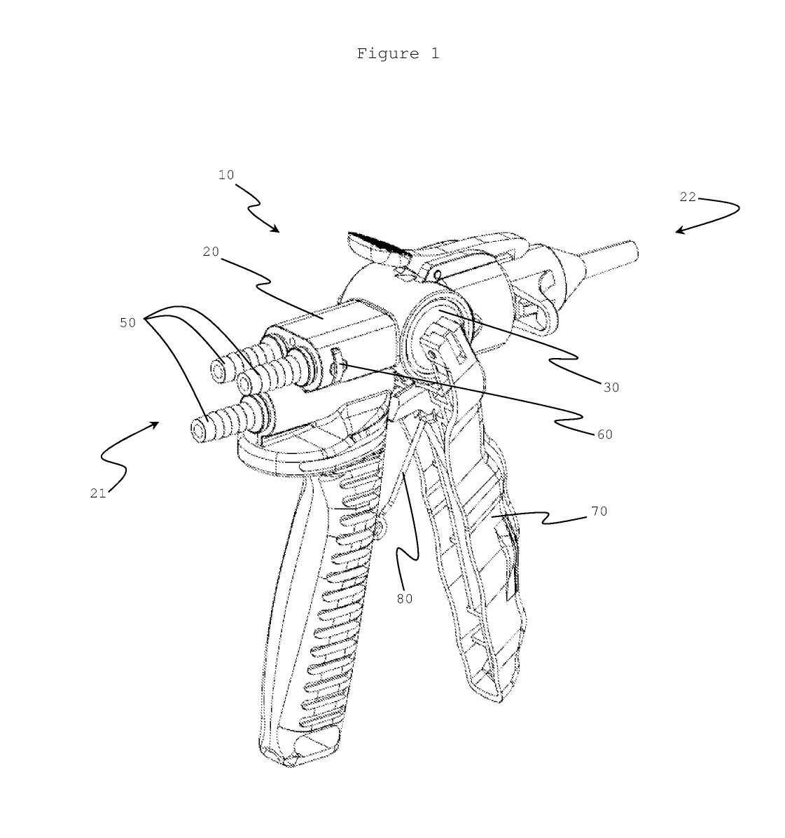

FIGS. 1-5 and the description below further illustrate embodiments and/or aspects of embodiments of a dispenser of the present invention.

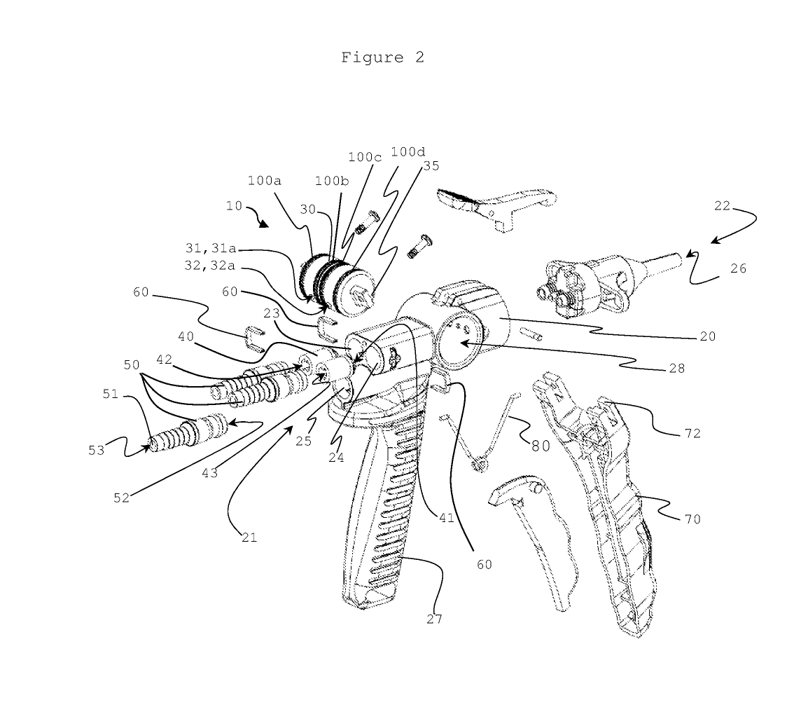

FIG. 1 illustrates dispenser 10 comprising housing 20 with feed end 21 and dispensing end 22, spool 30, sealing plugs 40 (not visible), nipples 50, fastener 60, trigger 70 and spring 80. Further perspectives and aspects of dispenser 10 are illustrated in FIGS. 2-5.

FIG. 2 illustrates an exploded view of dispenser 10 revealing elements of the dispenser. Housing 20 shows a feed end 21, dispensing end 22, feed channels 23, 24 and 25 and dispensing channel 26. Housing 20 further comprises handle 27 and spool receiver 28. Spool 30 fits into spool receiver 28 to form the spool valve of dispenser 10. Spool 30 has flow passage 31, 32, 33 and 34 (33 and 34 are not visible) which respectively have feed ends 31a, 32a, 33a and 34a (33a and 34a are not visible). Dispensing ends 31b, 32b, 33b and 34b of spool flow passages 31, 32, 33 and 34 are not visible. Spool 30 comprises tabs 35 with which spool 30 can be rotated from an open orientation to a closed orientation in housing 20. Spool 30 further has defined circumferentially around it four gasket grooves 38a, 38b, 38c, and 38d (none of which are visible in FIG. 2) in which O-rings 100a, 100b, 100c, and 100d respectively reside. Dispenser 10 has two deformable sealing plugs 40 that fit into feed channels 24 and 25. Sealing plugs 40 each have a spool end 41, feed end 42 and a flow channel 43 extending through each sealing plug 40. Spool end 41 of each sealing plug 40 presses against spool 30 of the dispenser. There is a nipple 50 that inserts into each of feed channels 23, 24 and 25. Each nipple 50 has an entrance end 51 and an exit end 52 and a flow channel 53. Exit end 52 presses against feed end 42 of the deformable sealing plugs 40 in feed channels 23 and 24. Fasteners 60 extend through housing 20 to hold nipples 50 in place within feed channels 23, 24 and 25. Dispenser 10 comprises trigger 70 with attachment means 72 that attach to tabs 35 of spool 30. Displacing trigger 70 towards or away from handle 27 rotates spool 30 either into an open orientation or a closed orientation in housing 20. Spring 80 serves to restore trigger 70 into a position away from handle 27, which positions spool 30 into a closed orientation. Squeezing trigger 70 towards handle 27 rotates spool 30 into an open orientation. Releasing trigger 70 allows spring 80 to move trigger 70 away from handle 27 and rotate spool 30 into a closed orientation.

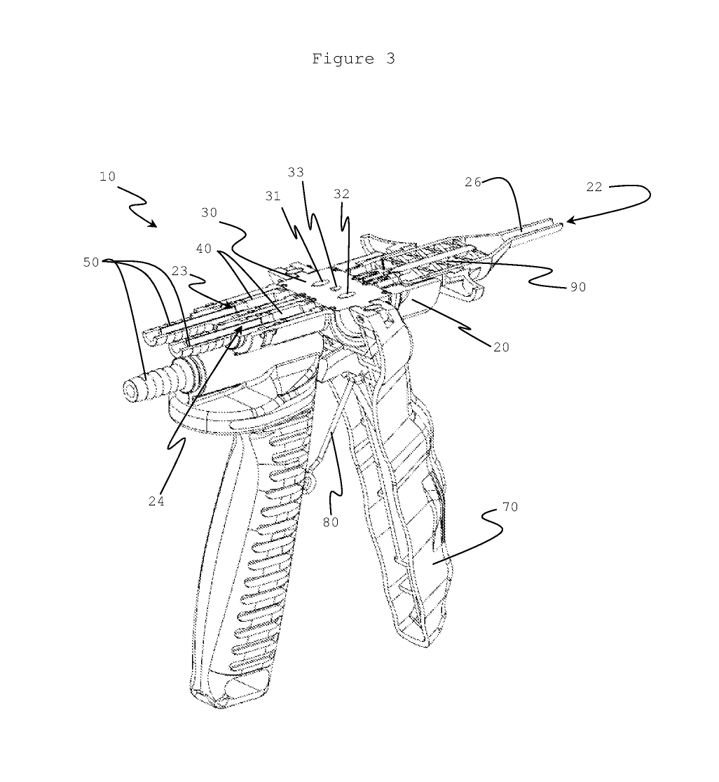

FIG. 3 illustrates a cut-away view of dispenser 10 with the top of the dispenser cut away to show the orientation of nipples 50, sealing plugs 40 and spool 30 in feed channels 23 and 24. Dispenser 10 has trigger 70 and spool 30 in a closed orientation and flow passages 31, 32 and 33 are all visible in spool 30. Also illustrated in this cut-away view is static mixer 90 that resides in fluid communication with and between feed channels 23, 24 and 25 (feed channel 25 not shown in FIG. 3) and dispensing channel 26 and serves to mix A and B components and pressurized gas together before being dispensed through feed end 22 of dispenser 10.

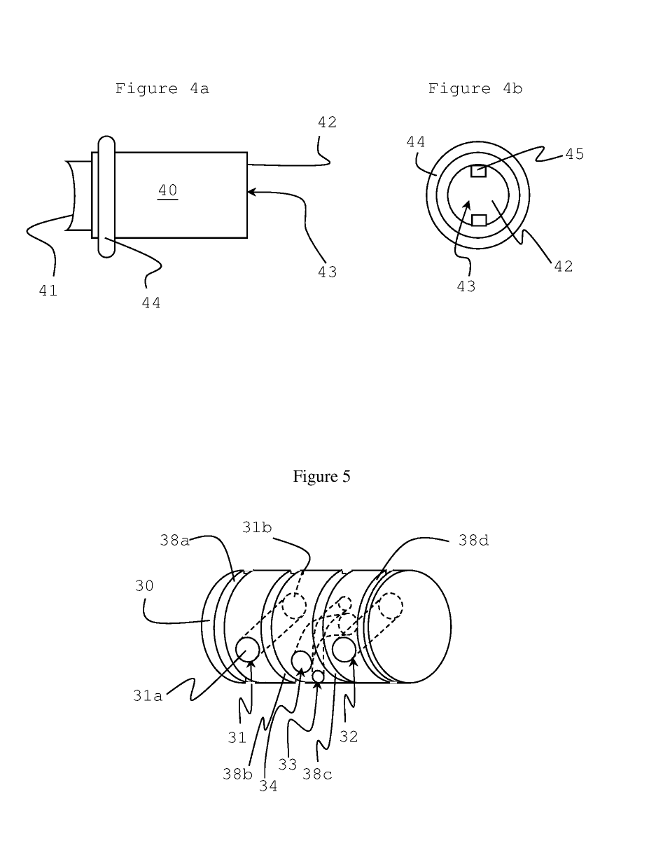

FIGS. 4a and 4b illustrate larger images of sealing plug 40 including a side view in FIG. 4a and an end view in FIG. 4b as viewed from feed end 42. Sealing plug 40 comprises a contoured profile on spool end 41 that conforms to the cylindrical body of spool 30. Sealing plug 40 also comprises lip 44 that extends circumferentially around sealing plug 40. Sealing plug 40 further comprises alignment features 45 that are protrusions extending into flow channel 43. Alignment features 45 identify the sides of sealing plug 40 corresponding to the furthest extending portion of spool end 41 and thereby allow alignment of the sealing the contour of spool end 41 from feed end 42.

FIG. 5 illustrates a spool 30 with flow passages 31, 32, 33 and 34. Flow passages 31 and 32 are first and second flow passages while flow passage 33 corresponds to the third flow passage and flow passage 34 is the fourth flow passage. Also evident are gasket grooves 38a, 38b, 38c and 38d that extend circumferentially around spool 30. Spool 30 in FIG. 5 is for use in a dispenser where the three feed channels are not coplanar. When in the open configuration, flow can occur from the feed channels through flow passages 31, 32 and 33, but not 34. When in the closed configuration, flow can occur through flow passage 34, but not 31, 32 and 33.

What is claimed is:

1. A dispenser (10) comprising:
(a) a housing (20) with a feed end (21) and an opposing dispensing end (22), the feed end having defined therein at least three feed channels (23, 24 and 25) and the dispensing end having defined therein at least one dispensing channel (26);
(b) a spool valve mounted in the housing between the feed end and dispensing end, the spool valve comprising a spool (30) with separate first, second and third flow passages (31, 32 and 33) and a fourth flow passage (34) that optionally intersects the third flow passage, where the flow passages are defined through the spool and each flow passage has a feed end opening (31a, 32a, 33a and 34a, respectively) and a dispensing end opening (31b, 32b, 33b and 34b, respectively), the spool has at least four gasket grooves (38a, 38b, 38c and 38d) defined circumferentially around the spool and in each of which a gasket (100a, 100b, 100c and 100d, respectively) resides so that each gasket presses against the spool and housing to form a seal around the circumference of the spool with a gasket groove defined on each side of the feed end opening and dispensing end opening of each of the four flow passages such that the feed end opening and dispensing end opening of the third and fourth flow passages residing between the same two gasket grooves while the first flow passage feed end opening and dispensing end opening are the only flow passage openings of the four flow passages residing between one pair of gasket grooves and the second flow passage feed end opening and dispensing end opening are the only flow passage openings of the four flow passages residing between a second pair of gasket grooves;
(c) a deformable sealing plug (40) in at least two feed channels positioned so as to be in a sealing orientation with the housing about the feed channel so as to prevent fluid communication through the feed channel around the sealing plug, the sealing plug having opposing spool end (41) and feed end (42) and a flow channel (43) extending through the sealing plug and through the opposing ends of the sealing plug, wherein the spool end of the sealing plug is pressing against and is in sealing contact with the spool, the entire sealing plug being elastomeric and deformable; and
(d) a nipple (50) in each of at least the two feed channels of the housing containing sealing plugs and extending inside and out from the feed end of the feed channels, the nipples having opposing entrance end (51) and exit end (52) and a flow channel (53) extending through each nipple, including through the exit and entrance ends, the nipples oriented such that the exit end of a nipple presses against the feed end of a sealing plug within the feed channel of the housing and such that the flow channels of sealing plug and nipple are in fluid communication, the nipples being free of screw threading that screws the nipple into the feed channel;
wherein the spool can reversibly rotate between: (i) an open position where each of the three distinct flow passages through the spool aligns in fluid communication each with distinct feed and dispensing channels of the housing with the first and second flow passages through the spool achieving fluid communication with a feed channel of the housing through a flow channel of a sealing plug and nipple and through a dispensing channel; and (ii) a closed position where the first and second flow passage through the spool are not in fluid communication with a feed channel of the housing and the fourth flow passage is in fluid communication with feed and dispensing channels of the housing that the third flow passage was in fluid communication with when in the open position.

2. The dispenser of claim 1, wherein the fourth flow passage has a larger average cross sectional area than the third flow passage.

3. The dispenser of claim 1, wherein the third and fourth flow channel intersect within the spool.

4. The dispenser of claim 1, wherein the spool end of the sealing plugs have a profile that generally matches that of the spool profile and each sealing plug is aligned in a feed channel so that the profile of the spool end of the sealing plug is aligned and conforms to the profile of the spool.

5. The dispenser of claim 4, further characterized by the sealing plug having alignment features (45) that facilitate insertion into a feed channel in a known orientation so that the contour of the spool end forms to the contour of the spool.

6. The dispenser of claim 1, wherein the feed channels of the housing that contain a sealing plug are each free of threading for screwing an element into the feed channel

7. The dispenser of claim 1, further characterized by the first and second feed channels being coplanar and the third feed channel being non-coplanar with any other flow channel and wherein the spool is cylindrical with the first and second flow passages extending radially through the spool and capable of aligning with two feed channels and the third flow passage entering in a non-coplanar orientation with the other feed channels that are coplanar but exiting the spool aligned in a linear orientation with respect to the other flow passages such that when the spool is oriented in an open orientation the non-planar entrances to the flow passages each align with a different one of the feed channels and fluids flowing through the feed channels proceed through the flow passages of the spool so as to exit the spool flow passages aligned along a plane.

8. The dispenser of claim 1, further comprising a trigger (70) attached to the spool so that when the trigger is moved in a first direction the spool rotates to an open orientation and aligns the flow passages of the spool into fluid communication with the feed channels of the housing and when the trigger moves in a direction opposite to the first direction, the spool rotates into a closed orientation.

9. A method of using the dispenser of claim 1, the method comprising: (A) simultaneously supplying under pressure: (i) a liquid isocyanate component into a first feed channel of the housing through the flow channels of a nipple and plug residing in the first feed channel; (ii) a liquid polyol component into a second feed channel of the housing through the flow channels of a nipple and plug residing in the second feed channel; and (iii) a gas into a third feed channel of the housing; (B) positioning the spool of the dispenser to allow the liquid isocyanate component to flow through the first flow passage of the spool, the polyol component to flow through the second flow passage of the spool and the gas to flow through the third flow passage of the spool; and (C) dispensing a combination of the isocyanate component, polyol component and gas out from the dispensing channel of the housing.

10. The method of claim 9, further comprising a step (D) after step (C) where step (D) is positioning the spool of the dispenser in a closed position where the first and second flow passages of the spool are no longer in fluid communication with the first and second feed channel of the housing and where the fourth flow passage of the spool is in fluid communication with the third flow channel of the housing and gas flows through the fourth flow passage of the spool and out from the dispensing channel of the housing.
